(19) United States
(12) Patent Application Publication
(10) Pub. No.: US 2020/0305267 A1
(43) Pub. Date: Sep. 24, 2020

(54) Wide Area Shield for use in a Plasma Cutting Torch.

(71) Applicant: American Torch Tip, Co., Bradenton, FL (US)

(72) Inventors: Steven E. Dadig, Lakewood Ranch, FL (US); Matthew Joel Merrill, Bradenton, FL (US)

(21) Appl. No.: 16/358,130

(22) Filed: Mar. 19, 2019

(51) Int. Cl. H05H 1/28

(52) U.S. Cl. CPC H05H 1/28; H05H 2001/3457

(57) ABSTRACT

A wide area shield for use in a plasma cutting torch. The wide area shield has a projected surface that covers at least 75% of the distal end of the plasma cutting torch when viewed in a plane perpendicular to the central axis of the torch. The wide area shield is actively cooled by at least two separate cooling flows. One possible cooling flow is liquid and contacts at least 25% of the total surface area of the wide area shield. A second possible cooling flow is gaseous and contacts at least 6% of the total surface area of the wide area shield. The increased projected area is achieved by increasing the axial length of the shield and increasing the shielding surface of the wide area shield which also allows for a thicker cross-sectional area of the wide area shield as measured perpendicularly from the shielding surfaces.

### BACKGROUND OF THE INVENTION

### A. Field of Invention

The present invention is in the technical field of plasma cutting torches. More particularly, the present invention is in the technical field of consumables used to shield the nozzle of a plasma cutting torch during cutting operations.

### B. Description of Related Art

Prior art plasma cutting torches have been well-known for many years and are used in cutting and piercing metal work pieces. Plasma cutting devices, such as plasma torches, use an anode and cathode to generate an electrical arc that ionizes a working gas, usually compressed air or oxygen. The plasma cutting torch begins the cutting process by circulating a working gas through the torch and out the nozzle, and onto a work piece, generally a piece of plate metal. The working gas is converted to a plasma state via a starting process that can require contact between the plasma torch and work piece to complete the necessary circuit or be a contact less means using an internal starting circuit. During the process of cutting metal with a plasma cutting torch, molten metal, commonly called spatter, will be blown back onto the face of the plasma cutting torch. As the ionized working gas or plasma forces droplets of molten metal into the work piece, spatter bounces or rebounds toward the plasma torch. Spatter is most likely to occur during the initial piercing of the work piece, prior to plasma and molten metal passing entirely through the work piece. The molten droplets quickly solidify after contact with the plasma torch. The solidified spatter can build up on the plasma torch and cause several problems, such as thermal hot spots, blockage of flow channels, and erosion of material.

Plasma torches generally employ a shield to protect the nozzle of the plasma cutting torch from molten splatter. The shield is concentric with the plasma torch and extends radially to protect the nozzle. Due to the proximity of the shield to the exit orifice of the nozzle, it is exposed to high temperatures. The problem of spatter sticking to the shield can be reduced by cooling the shield to prevent localized melting of the shield material that is impacted by spatter which effectively welds itself to the shield during the operation of the torch. The dimensions of shield determine the amount of shielding surface provided by the shield. When the proximal end of a shield is viewed at a plane perpendicular to the central axis of the shield, the shield appears circular and the shielding surface can be viewed as a projected area represented by the inner and outer diameter, relative to the central axis, of the shielding surfaces. The shield is generally made from a conductive material with good heat transfer and electrical conduction properties, typically a copper alloy. A fluid channel can be created between the shield and nozzle of the plasma cutting torch. The fluid that flows between the shield and nozzle is generally a shielding gas. The shielding gas flow typically offers a relatively small or negligible amount of heat transfer to the shield. Prior art plasma torches have attempted to increase the amount of active cooling in a shield by exposing a portion of the shield to a liquid coolant flow, such as U.S. Pat. No. 8,212,173 (hereinafter '173 patent). As seen in FIG. 4 of the '173 patent, a small portion of the outer diameter (second surface 70) of the shield 50 is exposed to liquid coolant. The location of the liquid cooled surface 70 in the '173 patent is located at the opposite end of the shield's exit orifice 30. In FIG. 5 of the '173 patent an embodiment of the prior art shield 130 is shown with a flange 150 that is at the location of the liquid cooling. The flange 150 also appears to be the thinnest portion of shield 150. The effectiveness of the liquid cooling of the shield 130 is limited by the amount of heat transfer that can take place, via conduction, through the section of the flange 150 that attaches to the other portions of the shield 150. The projected surface are of the shield 130 is ˜36% of the total surface area of the shield 130 or 730 mm² (1.13 in²). The combined projected surface of the shield 50 and retainer cap 65, seen in FIG. 4 of the '173 patent, is 2016.77 mm² (3.13 in²). In this design the retainer cap 65 has a significant portion, all of the projected surface are of the retainer cap 65, that is susceptible to spatter.

Another prior art plasma cutting torch shield design can be seen in U.S. Pat. No. 6,320,156 to Yoshihiro et. al., hereinafter the '156 patent. As can be seen in FIG. 1 of the '156 patent, the shield cap 111 has a flange 111a that is in direct contact with cooling passage 145. The flange 111a is attached to the rest of the shield cap by a section that appears to be thinnest section of the shield cap 111. Again, heat transfer via conduction will be limited by the cross-sectional area of the shield cap 111. Additionally, the shield cap 111 of the '156 patent has a smaller outer diameter than the nozzle 107 and the section of the shield cap 111 that is not covered by the retainer cap 113 is only sufficient to cover the tip of the exit orifice of nozzle 107. The combined projected surface of the shield cap 111 and retainer cap 113, seen in FIG. 1 of the '156 patent, is 1656.13 mm² (2.57 in²), projected area of the shield cap 111 is 0.246 mm² (0.246 in²). In this design the retainer cap 113 is the majority of the projected surface of the plasma torch 101 that is susceptible to spatter. In practice the retainer cap 113 is plated, chrome or nickel, to help prevent spatter from attaching to the retainer cap 113.

### SUMMARY OF THE INVENTION

The present invention provides an extended life shield for use in a plasma cutting torch. The extension of the usable life of the plasma cutting torch shield is accomplished in part by increasing the amount of heat transfer from the water-cooled section of the shield by providing liquid cooling to the areas of the shield opposite or in proximity of the shielding surfaces, as well as increasing the amount of surface area, of the shield, exposed to liquid cooling. The life of the shield is also augmented by increasing the surface area and projected area of the shield exposed to molten metal blow black, or spatter. The increased area is achieved by increasing the outer diameter of the projected area exposed to spatter, which in turn increases the mass of shield. Increased mass allows for greater amounts of conductive heat transfer within the shield. Finally, the shield has internal cooling passages that allow for active cooling of the shield face by the gas flow.

### BRIEF DESCRIPTION OF THE DRAWINGS

Figures are not drawn to scale. The figures depict one or more embodiment of the present invention, additional embodiments are not illustrated.

FIG. 1 is a cross section of a partial plasma cutting torch assembly including an embodiment of the present invention;

FIG. 2 is a view of the embodiment of the present invention seen in FIG. 1 which is perpendicular to the view seen in FIG. 1 and depicts the proximal end of the of the present embodiment;

FIG. 3 is a cross section of the embodiment of the present invention seen in FIG. 1 along a cut plane that does not intersect the shield gas passages;

FIG. 4 is a cross section of the embodiment of the present invention seen in FIG. 1 along a cut plane that intersects the shield gas passages;

FIG. 5 is a cross section of a second embodiment of the present invention along a cut plane that intersects the shield gas passages;

FIG. 6 is a cross section of a third embodiment of the present invention along a cut plane that intersects the shield gas passages;

FIG. 7 is a cross section of a fourth embodiment of the present invention along a cut plane that intersects the shield gas passages;

FIG. 8 is a cross section of a fifth embodiment of the present invention along a cut plane that intersects the shield gas passages.

### DETAILED DESCRIPTION OF THE INVENTION

Referring now to the drawings, wherein like reference numerals designate identical or corresponding parts throughout the several views, embodiments of the invention are shown. The present invention is a wide area shield for use in a plasma cutting torch.

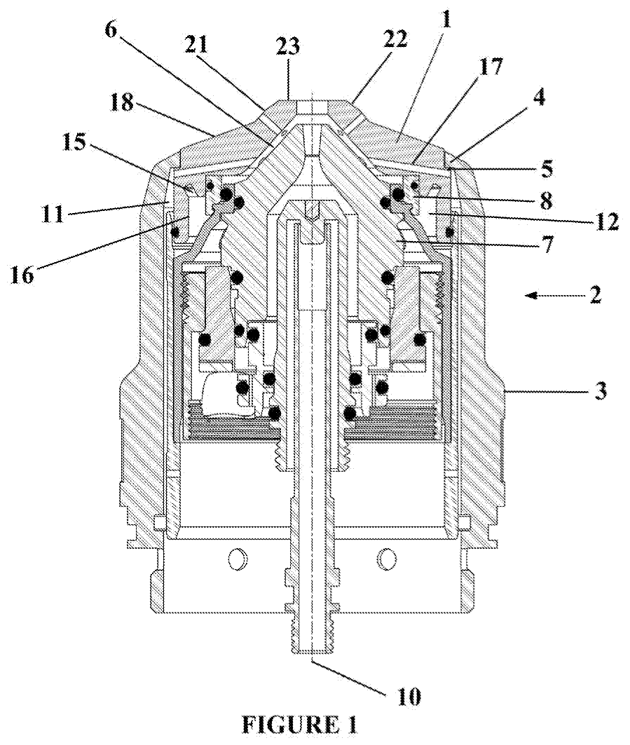

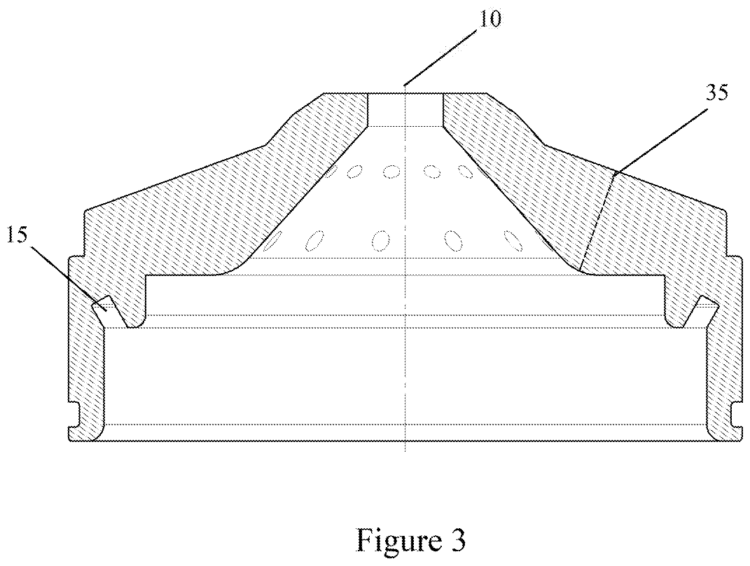

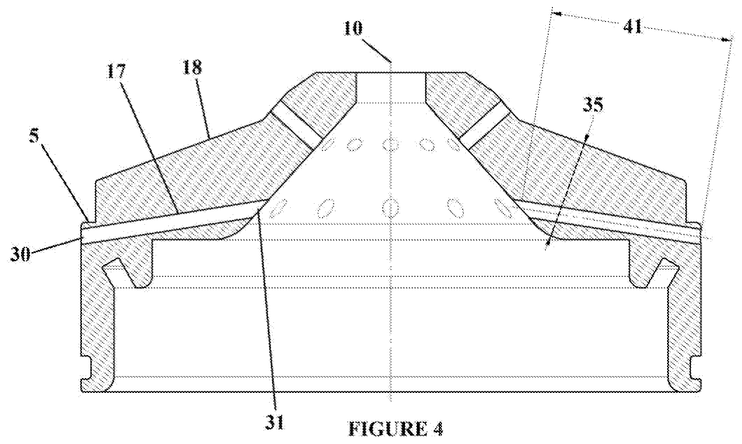

A cross sectional view of an embodiment of the present invention installed in a plasma cutting torch can be seen in FIG. 1. The wide area shield 1 can be seen in a plasma cutting torch assembly 2. The wide area shield 1 is located at the distal end of the cutting torch assembly 2 and is held in place concentrically, about central axis 10, to the plasma cutting torch assembly 2 by outer retaining cap 3 which is threaded to the plasma cutting torch body (not shown) and compresses the wide area shield 1 via a flange 4 on the inner diameter of the outer retaining cap 3 and lip 5 on the outer diameter of the wide area shield 1. The lip 5 of the wide area shield 1 represents ˜4.6% of the total diameter of the wide area shield 1. A gas flow path 6 is created by the gap between the wide area shield 1 and the nozzle 7. An insulating spacer 8 is used to separate the cathode and anode circuits of the plasma cutting torch assembly 2. The insulating spacer 8 is sealed via O-rings, depicted as black circles in FIG. 1, to prevent gas flow 11 and liquid cooling cavity 12 from leaking into each other. Liquid cooling cavity 12 is in direct contact with surface area increasing feature 15 and surface 16 of the wide area shield 1. Surface area increasing feature 15 and shielding surface 18 are on opposite sides of the wide area shield 1. The portions of wide area shield 1 between surface area increasing feature 15, gas flow path 6 and shielding surface 18 are the thickest portions the wide area shield 1 as seen in the cross-section 35 presented in FIGS. 3 and 4. The maximum thickness 35 of the wide area shield 1 as measured through and perpendicular to shielding surface 18 is 6.43 mm (0.253 inches). Shielding surface 18 is cooled via conduction from at least two sources of active cooling that cool the wide area shield 1 via convection from the active cooling sources. The liquid cooling cavity 12 provides active cooling and the series of shield gas passages 17 also provide active cooling, via forced convection heat transfer, which allows for heat to be conducted away from at least shielding surface 18 of wide area shield 1. Wide area shield 1 has a total shielding surface, exposed to spatter, that comprises at least shielding surface 18, shielding surface 21, shielding surface 22 and shielding surface 23.

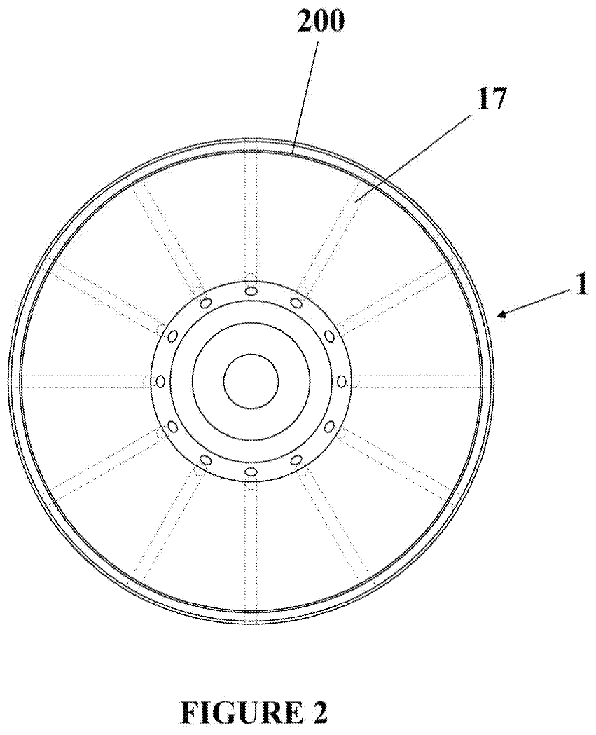

As seen in FIG. 2, the series of shield gas passages 17 are arranged concentrically about the center of wide area shield 1. In this embodiment of the present invention there are 12 shield gas passages 17 arranged concentrically about the central axis 10 in FIG. 1 or the center of the wide area shield 1 in FIG. 2. The shield gas passages 17 are at least equal in length, relative to the central axis 10, as the length of shielding surface 18. As seen in FIG. 4 shield gas passages 17 have gas inlet 30 and gas outlet 31. In the present embodiment of the invention shield gas passages 17 are longer then shielding surface 18 and shield gas passage length 41 measures 11.96 mm (0.471 inches) in length. The angle of the shield gas passages 17 relative to the shielding surface 23 is 9 degrees. The radial length of the shield gas passages 17, the horizontal length as measured perpendicular to the central axis 10, is 11.82 mm (0.4655 inches). The surface area of the 12 combined shield gas passages 7 is 459.9 mm² (0.71 in²), this represents 6.8% of the total surface area of the wide area shield 1. The total length of the wide area shield 1 as measured along the central axis 10 is 21.03 mm (0.828 inches). The total mass of wide area shield 1 is 82.87 grams. The outer diameter 200 of the projected surface of the wide area shield 1 can be seen in FIG. 2 and is defined by the inner diameter of lip 5. The projected surface of wide area shield 1 is 1183.22 mm² (1.834 in²) and the total projected surface of the surfaces exposed to spatter, projected surface of retaining cap 3 and wide area shield 1, is 2016.77 mm² (3.13 in²). The diameter of the total projected surface exposed to spatter is 50.67 mm (1.995 in) and the outer diameter 200 is 38.81 mm (1.528 in). The outer diameter 200 is 76.6% of the diameter of the total projected surface exposed to spatter.

In the embodiment of the present invention seen in FIGS. 1, 2,3 and 4 surface area increasing feature 15 is shown as a rectangular cavity that creates an annulus about central axis 10. In prior art shields the percentage of liquid cool surface area was less than 22% of the total surface area of the shield. The wide area shield 1 of the present invention has a liquid cooled surface area of at least 25% of the total surface area of the wide area shield 1. The rectangular anulus created by the revolution of surface area increasing feature 15 about central axis 10 allows for a total liquid cooled surface area of 1809 mm squared (2.804 inches squared) for wide area shield 1, which represents 27% of the total surface area of wide area shield 1. The ratio of the length of the shield gas passages 17 to the axial length of the wide area shield 1 is 0.57:1. The ratio of the length of the shield gas passages 17 to the radius of the wide area shield 1 is 0.59:1. The ratio of the radial length of the shield gas passages 17 to the radius of the wide area shield 1 is 0.58:1.

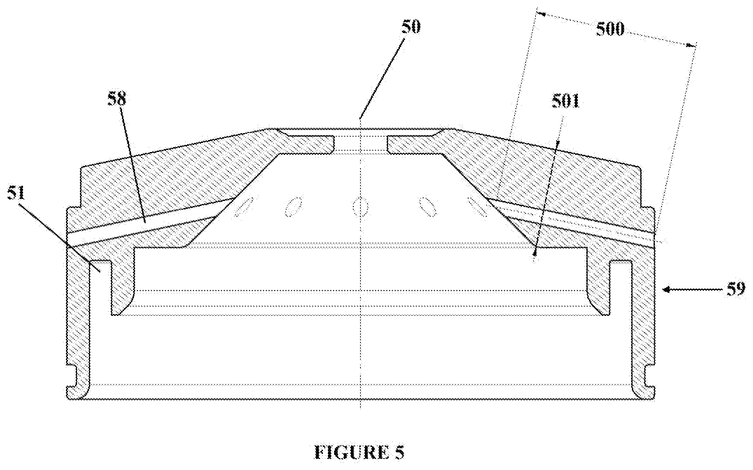

FIG. 5 shows another embodiment of the present invention, wide area shield 59. This embodiment has a surface area increasing feature 51 in the shape of a rectangle which produces an anulus when rotated about central axis 50. Surface area increasing feature 51 increases the total water cooled surface area of this embodiment of the present invention to 2210.32 mm² (3.43 in²), which represents 33% of the total surface area of the wide area shield 59. The total surface area of this embodiment is 7190.031 mm² (11.15 in²). The shield gas passages 58 have a shield gas passage length 500 which measures 11.28 mm (0.444 inches) at a 12 degree angle relative to central axis 50. The radial length of shield gas passages 58 is 11.04 mm (0.4345 inches). The total length of the wide area shield 59 as measured along the central axis 50 is 18.75 mm (0.738 inches). The surface area of the 12 combined shield gas passages 58 is 432.18 mm² (0.672 in²), this represents 6.01% of the total surface area of the wide area shield 59. The maximum thickness 501 of the wide area shield 59 as measured through and perpendicular to shielding surface 18 is 6.83 mm (0.269 inches). The total mass of wide area shield 59 is 83 grams. The ratio of the length of the shield gas passages 58 to the axial length of the wide area shield 59 is 0.60:1. The ratio of the length of the shield gas passages 58 to the radius of the wide area shield 59 is 0.55:1. The ratio of the radial length of the shield gas passages 58 to the radius of the wide area shield 59 is 0.54:1

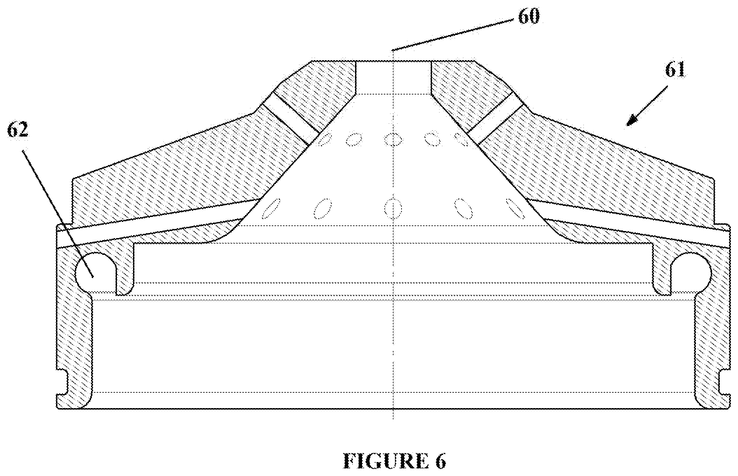

FIG. 6 shows another embodiment of the present invention, wide area shield 61. This embodiment has a surface area increasing feature 62 in the shape of a circle which produces an anulus when rotated about central axis 60. Surface area increasing feature 62 increases the total water cooled surface area of this embodiment of the present invention to 2036.13 mm² (3.16 in²). The total surface area of this embodiment is 6932.89 mm² (10.75 in²), at least 29% of the surface area of this embodiment of the present invention is water cooled.

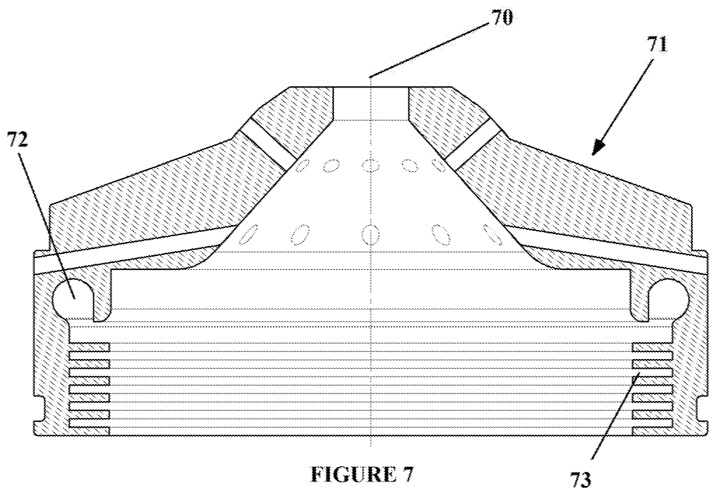

FIG. 7 shows another embodiment of the present invention, wide area shield 71. This embodiment has a surface area increasing feature 72 and surface area increasing feature 73. Surface are increasing feature 72 is in the shape of a circle and surface area increasing feature 73 is in the shape of a square tooth pattern. Both of these surface area increasing features, 72 and 73, produce an anulus when rotated about central axis 70. Surface area increasing features 72 and 73 increases the total water cooled surface area of this embodiment of the present invention to 5134.83 mm² (7.96 in²). The total surface area of this embodiment is 10032.24 mm² (15.55 in²), at least 51% of the surface area of this embodiment of the present invention is water cooled.

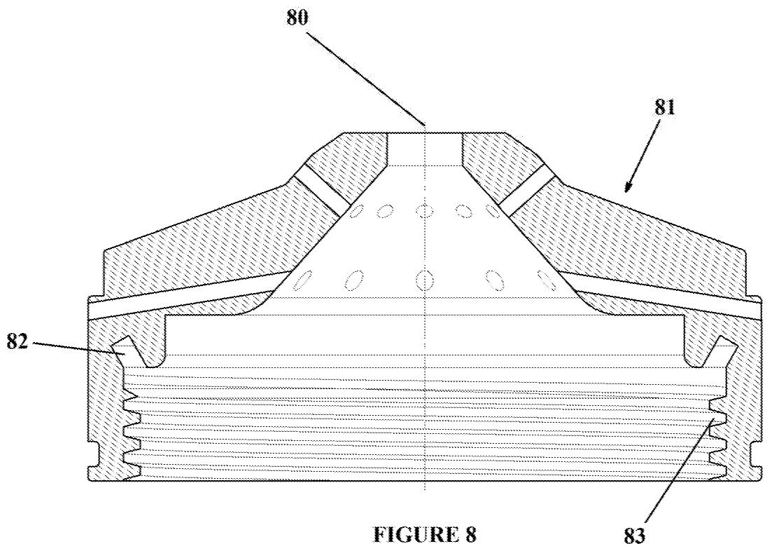

FIG. 8 shows another embodiment of the present invention, wide area shield 81. This embodiment has a surface area increasing feature 82 and surface area increasing feature 83. Surface area increasing feature 82 is in the shape of a rectangle and surface area increasing feature 83 is in the shape of an acme thread. Both of these surface area increasing features, 82 and 83, produce an annulus when rotated about central axis 80. Surface area increasing features 82 and 83 increases the total water cooled surface area of this embodiment of the present invention to 2518.06 mm² (3.90 in²). The total surface area of this embodiment is 7415.47 mm² (11.50 in²), at least 34% of the surface area of this embodiment of the present invention is water cooled.

1. A shield body for use in a plasma cutting torch, comprising
a central axis that extends from a proximal end of the shield body to a distal end of the shield body,
a central bore that extends from a proximal end of the shield body to a distal end of the shield body along the central axis,
an external surface of the shield body,
an internal surface created by the central bore,
a first section of the internal surface of the shield body contoured to mate with a nozzle body and create a first fluid passage when assembled in a plasma torch,
a first internal contact section of the internal surface of the shield body,
a liquid cooled section of the internal surface of the shield body,
a cooling passage created between the liquid cooled section of the internal surface of the shield body and a mating component of the plasma torch,
wherein the liquid cooled section of the internal surface of the shield has a liquid cooled surface area that has at least one surface area increasing feature.

2. The shield body of claim 1, wherein the shield body has a plurality of shield gas passages that have a radial length that is at 54% of the length of an outer radius of the shield body.

3. The shield body of claim 2, wherein the shield body has a total surface area comprising the internal surface, the external surface and a sum of the surface area of the shield gas passages, wherein the liquid cooled surface area of the shield body is at least 25% of the total surface area of the shield body.

4. The shield body of claim 3, wherein the surface area increasing feature is at least 8% of the total surface area of the shield body.

5. The shield body of claim 3, wherein the sum of the surface area of the shield gas passages is at least 6% of the surface area of the total surface area of the shield body.

6. The shield body of claim 1, further comprising a cylindrical section of the external surface of the shield body, wherein the cylindrical section of the external surface of the shield body begins at the distal end of the shield body and extends, along the central axis, for at least 66% of the axial length of the shield body along the central axis.

7. The shield body of claim 1, wherein the external surface of the shield body is not cooled by liquid cooling.

8. The shield body of claim 6, wherein the cylindrical section of the shield body has an outer diameter that is the largest outer diameter of the shield body.

9. A shield body for use in a plasma cutting torch, comprising
a central axis that extends from a proximal end of the shield body to a distal end of the shield body,
a central bore that extends from a proximal end of the shield body to a distal end of the shield body along the central axils,
an external surface of the shield body,
an internal surface created by the central bore,
a substantially cylindrical section of the shield body that begins at the distal end of the shield body and extends in the axial direction for at least half the axial length of shield body,
a plurality of shield gas passages arranged concentrically about the central axis and extending from an outer diameter of the cylindrical section of the shield body and extending in the radial direction through the shield body into the internal surface of the central bore of the shield body;
wherein a ratio of a length of the shield gas passages to a total axial length of the shield body is at least 0.5 to 1.

10. The shield body of claim 9, wherein the ratio of the length of the shield gas passages to a radius of the shield body is at least 0.5 to 1.

11. The shield body of claim 9, wherein a ratio of the radial length of the shield gas passages to a radius of the shield body is at least 0.5 to 1.

12. The shield body of claim 9, further comprising a total surface area that is the sum of the external surface, the internal surface and a combined surface area of the plurality of shield gas passages, wherein the combined surface area of the plurality of shield gas passages is at least 6% of the total surface area of the shield body.

13. The shield body of claim 12, further comprising a liquid cooled surface area.

14. The shield body of claim 13, wherein the liquid cooled surface area of the shield body is at least 25% of the total surface area of the shield body.

15. The shield body of claim 9, wherein the shield body is actively cooled by at least two active cooling flows.

16. A method for cooling a shield for use in a plasma cutting torch comprising:
providing a shield body for use in a plasma cutting torch comprising:
a shield body for use in a plasma cutting torch, comprising
a central axis that extends from a proximal end of the shield body to a distal end of the shield body,
a central bore that extends from a proximal end of the shield body to a distal end of the shield body along the central axis,
an external surface of the shield body,
an internal surface created by the central bore,
a first section of the internal surface of the shield body contoured to mate with a nozzle body and create a first fluid passage when assembled in a plasma torch,
a first internal contact section of the internal surface of the shield body,
a liquid cooled section of the internal surface of the shield body,
a cooling passage created between the liquid cooled section of the internal surface of the shield body and a mating component of the plasma torch,
wherein the liquid cooled section of the internal surface of the shield has a liquid cooled surface area that has at least one surface area increasing feature.

17. The shield body of claim 8, wherein the outer diameter of the shield body is at least 75% of a diameter of the plasma cutting torch exposed to spatter.

18. The shield body of claim 9, wherein the outer diameter of the shield body is at least 75% of a diameter of the plasma cutting torch exposed to spatter.

19. The shield body of claim 16, wherein the cylindrical section of the shield body has an outer diameter that is the largest outer diameter of the shield body.

20. The shield body of claim 19, wherein the outer diameter of the shield body is at least 75% of a diameter of the plasma cutting torch exposed to spatter.
